(19) United States
(12) Patent Application Publication
(10) Pub. No.: US 2006/0099346 A1
(43) Pub. Date: May 11, 2006

(54) Method for coating an architectual textile with at least one layer of a silicone elastomer using an aqueous silicone emulsion and an architectural textile with such a coating

(76) Inventors: Geraldine Martin, Sallieu (FR); Jean-Luc Perillon, Chateaux (FR)

Correspondence Address: JAMES C. LYDON, 100 DAINGERFIELD ROAD, SUITE 100, ALEXANDRIA, VA, 22314, US

(21) Appl. No.: 10/518,402

(22) PCT Filed: Jun. 17, 2003
(86) PCT No.: PCT/FR03/50012

§ 371 Date: Nov. 14, 2005

(30) Foreign Application Priority Data
Jun. 18, 2002 (FR) 02/07491

(51) Int. Cl. D03D 15/00; B05D 5/00; B05D 3/12; B05D 1/36; B29B 15/10

(52) U.S. Cl. 427/258; 427/355; 427/421.1; 427/372.2; 442/181

(57) ABSTRACT

A method for production of silicone membranes for architectural use which includes: depositing at least one layer of a polyorganosiloxane (POS) emulsion on an architectural textile, followed by crosslinking by polyaddition to give an elastomer such that the weight proportion of the coating as a proportion of the dry weight of the architectural textile is less than 0.2. The (POS) emulsion includes: (A) a POS with ═SiVinyl groups, (B) a POS with ═SiH groups, (C) a special adherence promoter (polyvinyl alcohol) or POS(OH), (D) a catalyst, (E) at least one surface active agent, (F) optionally a POS resin with ═SiVinyl groups, (G) optionally a crosslinking inhibitor, (H) optionally a pH stabilizing agent, (I) optionally a formulation additive, (J) optionally a filler and (K) water, such that the percentage by weight of adhesion promoter (C) with respect to the silicone phase is from 0.005 to 10%.

The present invention relates to a process for coating an architectural textile with at least one silicone elastomer layer, obtained from an aqueous polyorganosiloxane (POS) emulsion, which can be applied and crosslinked as a thin layer on the support and to the architectural silicone membranes thus obtained.

More specifically, the invention relates to the preparation of architectural silicone membranes obtained from coating an architectural textile, in particular but not limitingly a woven glass fabric, with a silicone.

This preparation consists in depositing a liquid silicone composition on the architectural textile and in then seeing to it that the thin layer applied crosslinks (cures) and is converted to an elastomer.

The term “architectural textile” is understood to mean a woven fabric or nonwoven fabric and more generally any fibrous support intended, after coating, for the preparation:
of shelters, of mobile structures, of textile constructions, of partitions, of flexible doors, of tarpaulins, of tents, of stands or of marquees;
of furniture, of cladding, of advertising displays, of windbreaks or of filter panels;
of solar protection devices, of ceilings and of blinds.

Silicone coatings act in particular as binder intended to improve the mechanical properties of architectural textiles, in particular the resistance to tearing, the resistance to fraying, the flexibility, or even the suitability for creasing.

Silicone coatings can also contribute to conferring a degree of impermeability and a water-repellent nature on architectural textiles.

In the case of noncombustible architectural textiles, such as woven glass fabrics, it is important for these silicone coatings not to place a strain on the flame retardancy and more especially the calorific value of such textiles.

In addition to protecting textile materials from heat and fire, the silicone coatings can also provide them with protection against other attacks and/or can confer thereon specific properties for certain applications (dielectric properties, for example).

There are several significant technical problems with regard to the preparation of elastomer coatings on architectural textiles.

A first problem is related to the operation of depositing/impregnating the noncrosslinked silicone composition on the textile. It is important that it be able to be carried out easily and rapidly (industrial rate) and, for obvious economic reasons, with reduced degrees of deposition (for example, less than 40 microns).

A second problem lies in the minimum level of adhesion which the silicone coating has to have on the textile.

A third problem results from the ambition to improve the performance of the silicone elastomer coating as regards its mechanical properties, its protective role and its water-repellent and waterproofing properties, without this harming the qualities of non-combustibility of certain architectural textiles, such as woven glass fabrics.

Taking the first problem targeted above into account has led persons skilled in the art to liquid silicone compositions of the aqueous silicone emulsions type, with or without filler. It remains to be determined whether these emulsions make it possible to correctly solve the second and third problems mentioned above.

European patent application EP-A-0 535 649 discloses a process for coating airbags which involves a silicone emulsion comprising:
a polyorganosiloxane (A) of the POS type, e.g. α,ω-dimethylhydroxysiloxy PDMS, as an emulsion in water in the presence of an anionic emulsifier,
an adhesion promoter (B) which is chosen from the group consisting of: the product of reaction between, on the one hand, an amino-functional silane or a hydrolysate of the latter and, on the other hand, an acid anhydride, an epoxyfunctional silane or a hydrolysate of the latter and/or an organo-silane having an isocyanate radical and a hydrolyzable radical or a hydrolysate of the latter (cf. example 3-aminopropyltriethoxy-silane+maleic anhydride),
a colloidal silica (C),
and a catalyst (D).

The emulsion used in this process suffers from the following disadvantages: inadequate compromise in terms of adhesion, of reactivity and of stability of the emulsions, in particular inadequate adhesion of the silicone to the support, incompatibility of the silanes used and of the surfactant used with polyaddition systems based on oils comprising ≡SiH and on platinum catalyst.

Likewise, European patent application EP-A-0 552 983 discloses a process of coating with an emulsion of the same type obtained from (A) an organo-polysiloxane having at least two alkenyl groups [α,ω-dimethylvinylsiloxy poly(dimethyl)vinylmethyl-siloxane], (B) an organohydropolysiloxane [α,ω-tri-methylsiloxy poly(methylhydro)siloxane] having at least three hydrogen atoms and (C) a platinum crosslinking catalyst, (D) a crosslinking inhibitor of the ethynyl-cyclohexanol type, (E) an adhesion promoter of the epoxidized trialkoxysilane or aminofunctional silane type (p. 4, line 34) and (F) optionally a reinforcing filler, such as a colloidal silica, by emulsification in water in the presence of an emulsifier (dodecyl-benzenesulfonate and poly(vinyl alcohol) PVA).

The emulsion used in this coating process suffers from the following disadvantages: inadequate adhesion (to the support)/stability (of the emulsion) compromise, in particular the use of dodecylbenzenesulfonate and of nonsalified aminofunctional silane leads to limited stability of the polyaddition emulsions.

European patent EP-B-0 758 666 relates to the coating of flexible supports using an aqueous emulsion comprising:
1) POSs of polydimethylsiloxane (PDMS) type vinylated at the chain end (vinyl-dimethylsiloxy);
2) hydrogenated POSs of α,ω-trimethylsiloxy poly(methylhydro)(dimethyl)siloxane type;
3) a platinum catalyst of the Karstedt platinum type;
4) an adhesion promoter produced by the reaction between a vinyltriacetoxysilane and a trimethoxysilane functionalized by a glycidyl radical;
5) a crosslinking inhibitor of the ethynyl-cyclohexanol type;
6) a silicone resin of MT type with M=(Me₃SiO_{1/2}) and T=(MeSiO_{3/2});
7) an emulsifier of the sodium dodecyl-benzenesulfonate type.

This polyaddition silicone emulsion has a favored application in the preparation of textile coating coverings (airbag: polyamide support).

European patent application EP-A-1 010 721 discloses the same emulsion as that disclosed in EP-B-0 758 666, with an extra additive composed of carbon black.

Patent application FR-A-2 738 830 relates to the coating of a textile material using an aqueous polyorganosiloxane emulsion. This emulsion is obtained by mixing a preemulsion A and a preemulsion B.

The preemulsion A comprises:
1) POS oil of α,ω-dimethylvinylsiloxy PDMS type;
2) a hydrogenated POS oil of the α,ω)-dimethylhydrosiloxy POS type;
3) a hydrogenated POS silicone oil of the poly(dimethyl)(methylhydro)siloxane type;
4) an adhesion promoter of the following type: vinyltrimethoxysilane, 3-glycidoxy-propyltrimethoxysilxane (GLYMO) or 4-epoxy-cyclohexylethyltrimethoxysilane, chelates of butyl orthotitanate type, or, finally, as regards silicone compositions which can be crosslinked by polyaddition, aminated silanes of aminofunctional trimethoxy- or triethoxysilane type;
5) a crosslinking inhibitor of the ethynyl-cyclohexanol type;
6) and fillers=colloidal silica rendered hydrophobic in silicone oil.

The preemulsion B comprises:
1′) α,ω-dimethylvinylated POS oil identical to that of the emulsion A;
4′) an adhesion promoter of the butyltitanate type;
7) a platinum catalyst;
6′) colloidal filler of the same type as in the emulsion A.

The preemulsions A and B are respectively prepared by stirring the compositions described above in the presence of water and of poly(vinyl alcohol) (PVA 25/140 Rhodoviol®). Once obtained separately, the preemulsions A and B are mixed with one another.

The process for the preparation of this aqueous silicone emulsion is not optimized. The following disadvantages may be noted: very coarse emulsion, relatively inflexible and expensive process as it is necessary to prepare intermediate silicone mixtures, difficulty in preparing highly concentrated emulsions.

In this state of the art, one of the essential objectives of the present invention is to provide a process for coating an architectural textile using a silicone emulsion which can be crosslinked by poly-addition and which has Theological properties such that it can be easily deposited/applied on the architectural textile at high speed and according to limited degrees of deposition, for example less than 40 g/m².

Another essential objective of the invention is to provide a process for forming fine coatings (thin layers) for protecting architectural textiles, these silicone elastomer coatings having excellent mechanical qualities (cohesion, flexibility) and conferring, on the architectural textile, good resistance to fraying and to tearing and good suitability for creasing.

Another essential objective of the invention is to provide a process for forming fine coatings (thin layers) for protecting architectural textiles in which deposition is easy and the amounts of emulsion employed are limited and which results in silicone-coated supports possessing good qualities of noncombustibility, expressed, for example, by a gross calorific value, measured according to NFP 92510, of less than 4200 kJ/kg and preferably of less than 2500 kJ/kg.

Another essential objective of the invention is to provide a process for forming, on inorganic or polymeric architectural textiles which are not very favorable to adhesion, silicone coatings which adhere to the fibers and which confer thereon nonstick, water-repellent and impermeable properties and which correspond to the specifications of deposition which is easy, in a limited amount and of reduced cost.

Another essential objective of the invention is to provide a silicone coating process with regard to architectural textiles, in order to form protective, impermeable, optionally noncombustible, flexible and resistant elastomeric coatings, using an emulsion with a composition such that, for architectural textiles, the elastomeric film is a good binder capable of giving strength, cohesion and flexibility to the coated textiles while limiting as far as possible the phenomenon of marking upon folding.

Another essential objective of the invention is to provide a silicone coating process in which use is made of an emulsion which is chemically stable (retention of the ≡SiH groups and of the reactivity) and physically stable (limited creaming and limited coalescence during storage of the emulsion) and which exhibits good characteristics in terms of reactivity (crosslinking by polyaddition) and of adhesion to the support, by drying the treated textile.

Another essential objective of the invention is to provide a process for coating an architectural textile using an aqueous silicone emulsion which can be crosslinked by polyaddition and which has the specifications stated above, this process having to be simple, economical and industrial while making it possible to produce coated architectural textiles which are flexible, are not subject to marking upon folding, are resistant to tearing and to fraying, and optionally have a noncombustible nature, expressed, for example, by a Gross Calorific Value (GCV), measured according to NFP 92510, of less than 4200 kJ/kg and preferably of less than 2500 kJ/kg.

Another essential objective of the invention is to provide architectural textiles coated with a thin film of silicone elastomer resulting from the coating and the crosslinking by polyaddition of an aqueous silicone emulsion, according to a process of the type of that defined in the above objectives, these coated architectural textiles being intended for the preparation of membranes for interior and exterior textile architecture and solar protection.

These objectives, among others, are achieved by the present invention, which relates first of all to a process for preparing architectural silicone membranes by coating an architectural textile with at least one silicone elastomer layer, characterized in that it comprises the following stages:
a stage of deposition, on said architectural textile, of at least one layer of an aqueous polyorganosiloxane (POS) emulsion which can be crosslinked to give an elastomer by polyaddition reactions, which emulsion comprises:
   (A)at least one POS exhibiting, per molecule, at least two unsaturated functional groups of C₂-C₆ alkenyl type bonded to silicon,
   (B) at least one POS exhibiting, per molecule, at least three hydrogen atoms bonded to silicon,
   (C) at least one special adhesion promoter chosen from the group of compounds consisting of protective hydrocolloids, hydroxylated silanes and/or POSs carrying, per molecule, at least one hydroxyl group and at least one aminated and salified functional group, and their mixtures,
with the condition according to which the percentage by weight of the adhesion promoter (C) with respect to the silicone phase is strictly within the range from 0.005 to 10%, preferably from 0.03 to 5% and more preferably still from 0.05 to 4%,
   (D) at least one catalyst,
   (E) at least one surfactant,
   (F) optionally at least one POS resin comprising at least two alkenyl groups,
   (G) at least one crosslinking inhibitor,
   (H) optionally at least one pH regulating agent,
   (I) optionally at least one formulation additive,
   (J) optionally a filler,
   (K) and water,
and then a crosslinking stage, so as to obtain an architectural textile coated with an elastomer layer, so that the ratio of the weight of the coating, expressed on a dry basis, to the weight of the architectural textile is less than 0.2 and preferably between 0.05 and 0.11.

Preferably, the amount by weight of adhesion promoter (C)/surface developed by the textile ratio lies within the range from 0.1 to 10 mg/m², preferably from 0.2 to 5 mg/m².

The term “surface developed by the textile” is understood to mean, in accordance with the invention, the surface developed by the fibers which constitute the architectural textile and which will be covered by the emulsion.

The deposition stage is advantageously a coating.

The coating stage can be carried out in particular by knife, in particular by knife over roll, floating knife and knife over carpet, by padding, in particular by squeezing between two rolls, or also by licking roll, rotary machine, reverse roll, by transfer, by screen printing, by heliography or by spraying.

One or both faces of the textile material can be coated, the coating of both faces then advantageously being carried out by padding after impregnation of the woven fabric with the emulsion. After passing between the rolls, the textile is uniformly coated with a fine layer of emulsion. Drying and crosslinking, preferably by hot air or infrared radiation, in particular from 30 s to 5 min, at a crosslinking temperature not exceeding the decomposition temperature of the substrate, are subsequently carried out.

When the coating is carried out on a single face, a knife is preferably used. The emulsion is deposited continuously on the upper face of the textile and then passes under the knife, before drying and crosslinking as above.

Preferably, the coating is carried out:
by immersing the architectural textile in a bath of emulsion as defined above,
by draining, preferably by pressing between rolls,
and then by crosslinking, preferably under thermal activation when the crosslinking is carried out according to a polyaddition mechanism.

The elastomer layer is preferably between 5 and 200 g/m². In the case of a two-component emulsion, the process comprises a preliminary stage consisting in mixing the two components.

Advantageously, the architectural textile is a woven fabric, a nonwoven fabric, a knitted fabric or more generally any fibrous support comprising fibers and/or fibers chosen from the group of materials consisting of: glass, silica, metals, ceramic, silicon carbide, carbon, boron, natural fibers, such as cotton, wool, hemp or flax, artificial fibers, such as viscose, or cellulose fibers, synthetic fibers, such as polyesters, polyamides, polyacrylics, chlorofibers, polyolefins, synthetic rubbers, poly(vinyl alcohol), aramids, fluorofibers, phenolics and the like.

The architectural textile, when it is chosen from inorganic materials, such as glass, silica, metals, ceramic, silicon carbide, carbon or boron, has, in a noteworthy way, once coated, a Gross Calorific Value (GCV) which is less than or equal to 4200 kJ/kg, preferably less than or equal to 2500 kJ/kg.

Advantageously, the coated architectural textiles exhibit a total weight of less than 1200 g/m² and preferably of between 100 and 500 g/m² and make it possible to prepare composite membranes exhibiting good noncombustility properties for interior and exterior architecture or solar protection.

The aqueous silicone emulsion employed in the process according to the invention is of the type of that which can be crosslinked by polyaddition at room temperature (RTV) it being known that this crosslinking catalyzed by platinum can be activated thermally (100-200° C.).

The aqueous silicone emulsion of the process according to the invention adheres to numerous architectural textiles, for example made of glass fibers, optionally made of synthetic textile fibers, of the polyester or polyamide type.

As regards architectural textiles of inorganic type, the process using the above emulsion makes it possible to obtain woven glass fabrics coated with silicone elastomers as thin layers which are water repellent, which have good mechanical properties of flexibility, of resistance to tearing and of resistance to fraying, and which have a low calorific value (for example, GCV≦2500 kJ).

One of the essential constituents of the emulsion employed in the process according to the invention is the special adhesion promoter (C), which is carefully selected in order for the adhesion to be introduced:
by at least one protective hydrocolloid, preferably PVA, which can also act as surfactant (E), in combination or not in combination with other emulsifiers,
or by specific silanes and/or POSs which are carefully selected, namely hydroxylated and amino-salified silanes and/or POSs,
or alternatively by a protective hydrocolloid, preferably PVA, and by hydroxylated and amino-salified silanes and/or POSs.

According to a first embodiment of the invention, the protective hydrocolloid, preferably PVA, acts solely as adhesion promoter (C).

In accordance with a second embodiment of the invention, the surfactant (E) can be at least partly composed of at least one protective hydrocolloid, preferably a PVA.

In the first embodiment, the protective hydrocolloid, preferably PVA, is present in a reduced amount in the emulsion so that it can only act fully as adhesion promoter (C) and imperfectly as emulsifier. The result of this is that the emulsion has to comprise a main emulsifier or surfactant (E).

In the second embodiment of the invention, the protective hydrocolloid, preferably PVA, adhesion promoter and emulsifier, is present in a proportion of 1.5 to 7% of dry PVA with respect to the total weight of the silicone oils.

Qualitatively, it may be pointed out that the protective hydrocolloid is preferably a poly(vinyl alcohol) (PVA) or a PVA blend and preferably the PVA grades which, in aqueous solution (at 4% and at 20° C.), have a typical dynamic viscosity (tdη) of between 5 and 40 mPa·s, preferably between 10 and 30 mPa·s, and an ester value of greater than or equal to 80, preferably of greater than or equal to 100 and in particular of between 120 and 200.

Preferably, the PVA is employed in the form of an aqueous solution with a typical dynamic viscosity (tdη) of between 5 and 40 mPa·s, preferably between 10 and 30 mPa·s, and with an ester value of greater than or equal to 80, preferably of greater than or equal to 100 and in particular of between 120 and 200.

Poly(vinyl alcohol)s (PVAs) are compounds obtained indirectly from their esters by hydrolysis in an aqueous medium or by alcoholysis in an anhydrous medium. In practice, the esters used as starting material are commonly poly(vinyl acetate)s. Generally, the lysis of the esters resulting in the PVAs is not complete. Acyl radicals remain in the molecule, the proportion of which influences the properties of the PVA, in particular its solubility. One form of definition of PVAs is thus based on the indication of the ester value (EV), which is inversely proportional to the degree of hydrolysis. The EV is measured in a way known per se, by neutralization of the possible acidity of the poly(vinyl alcohol), saponification of the acyl groups and titration of the excess alkalinity.

The poly(vinyl alcohol)s according to the invention are also characterized by their degree of condensation, which can be evaluated by the determination of the dynamic viscosity of a typical solution (designated by tdη in the present account), it being known that this variable increases as the degree of condensation increases.

The tdη viscosity corresponds to the coefficient of dynamic viscosity of a 4% by weight aqueous PVA solution, measured at a temperature of 20±5° C. using a Ostwald viscometer.

Mention may also be made, as other protective hydrocolloid, of water-dispersible sulfonated polyesters, in particular of sulfonated poly(ethylene terephthalate) type.

Water-dispersible sulfonated polyesters are known products which are commercially available. They can be prepared by cocondensation of an organic diacid (such as a saturated or unsaturated aliphatic diacid, an aromatic diacid, a diacid exhibiting several aromatic nuclei or an arylaliphatic diacid), one of its diesters or its anhydride and of a sulfonated organic diacid or one of its diesters with a diol, in the presence of a normal polyesterification catalyst, such as tetraisopropyl orthotitanate.

Mention may be made, as starting monomers commonly used for the preparation of water-dispersible sulfonated polyesters, as:
organic diacids: of saturated or unsaturated aliphatic diacids or aromatic diacids, such as succinic acid, adipic acid, suberic acid, sebacic acid, maleic acid, fumaric acid, itaconic acid, orthophthalic acid, isophthalic acid or terephthalic acid, the anhydrides of these acids or their diesters, such as the dimethyl, diethyl, dipropyl or dibutyl esters. The preferred compounds are adipic acid, orthophthalic acid, isophthalic acid and terephthalic acid;
sulfonated organic diacids: sodium sulfonate diacids or their diesters, such as dialkyl isophthalates and dialkyl sulfosuccinates, for example sodium dimethyl isophthalate-5-sulfonate or sodium dimethyl sulfosuccinate;
diols: aliphatic glycols, such as ethylene glycol, diethylene glycol, dipropylene glycol and higher homologs, 1,4-butanediol, 1,6-hexanediol, neopentyl glycol and cyclanic glycols, such as cyclohexanediol or dicyclo-hexane-diolpropane. The diols preferably chosen are ethylene glycol and diethylene glycol.

The preferred water-dispersible sulfonated polyesters are those which have a number-average molar mass of between 10,000 and 35,000, an acid number of less than 5 mg of KOH/g and a sulfur level of between 0.8 and 2% by weight, preferably between 1.2 and 1.8%. Use may be made in particular, as polyesters of this type, of the products sold by Rhodia under the trade name Gerol PS20.

The hydroxylated and aminosalified silanes which can be constituent components of the promoter (C) are obtained from nonsalified precursors, among which may be mentioned, as examples, monoaminetrihydroxy-monosilanes, such as: NH₂(CH₂)₃—Si(OH)₃, optionally oligomerized by partial condensation of the SiOH groups.

Having specified this, the water-soluble adhesion promoter (C) preferably comprises hydroxylated, aminated and salified POSs.

These aminated and salified POSs constituting the promoter (C) are advantageously formed of several repeat units of following mean formula (I)
(R¹)ₓ(R²)_{y}(OH)_{z}SiO_{4-(x+y+z)/}2 (I)

in which:

R¹ represents a nitrogen-free monovalent group, identical or different in nature from one repeat unit to another, corresponding to a C₁-C₆ alkyl, an aryl, a C₂-C₈ alkenyl or an acrylate, each of these groups optionally being substituted,

R² is identical or different in nature from one repeat unit to another and corresponds to the following formula:
—R⁴˜N⁽⁺⁾R⁵R⁶X⁽⁻⁾
R⁴ is an optionally substituted C₁-C₁₀ hydrocarbon radical,
the R⁵ and R⁶ groups are identical or different and represent hydrogen or an optionally substituted C₁-C₁₀ hydrocarbon radical or —R⁴—NH₃⁽⁺⁾X⁽⁻⁾,
or alternatively the R⁵ and R⁶ groups are other than hydrogen and together form a 5- to 7-membered ring including at least one heteroatom, preferably nitrogen or oxygen,
and X represents a counteranion chosen from carboxylates or halides, and;

x, y and z are positive whole or decimal numbers of less than 4;

and x+y+z<4.

Preferably, the aminated and salified POS is a resin exhibiting a mean silicon functionality of greater than 2, corresponding to x+y<2:
x preferably being <2 and more preferably still 0.1≦x≦1;
y preferably being <1.2 and more preferably still 0.1≦y≦1.1.

This corresponds to a POS resin:
on the one hand, hydroxylated and comprising T and optionally M and/or D and/or Q siloxyl units or alternatively Q and M and/or D and/or T siloxyl units;
on the other hand, carrying at least one aminated and salified unit.

The M, D, T and Q siloxyl units of the POS (C) are defined as follows:
M unit=R₃SiO_{1/2}
D unit=R₂SiO_{2/2}
T unit=RSiO_{3/2}
Q unit=SiO_{4/2}

The R radicals are identical or different and correspond:
to an R¹ radical as defined above (such as, for example, an alkyl (e.g. methyl, ethyl, isopropyl, tert-butyl and n-hexyl) radical, a hydroxyl or an alkenyl (e.g. vinyl or allyl))
or alternatively an aminosalifiable or salified R² unit as defined above.

Mention may be made, as example of linear hydroxylated POS resin which can be used as promoter (C), of PolyMethylSiloxane, the two ends of which comprise a hydroxyl and each silicon atom of which carries an aminosalifiable or salified unit.

The more particularly selected resins are those of the T(OH), DT(OH), DQ(OH), DT(OH), MQ(OH), MDT(OH) or MDQ(OH) type or mixtures thereof. In these resins, each OH group is carried by a silicon atom belonging to a D, T or Q unit.

These resins are condensation products (mono- or poly-condensation, hetero- or homocondensation) of POS monomers, oligomers or polymers carrying condensable groups, preferably of hydroxylic nature.

In addition to these hydroxyls, the promoter (C) comprises one or more aminosalifiable or salified units which are identical to or different from one another.

In these units, the amine can be primary, secondary or tertiary. According to alternative forms, it can be included in a ring or can be included in isocyanurate or HALS (piperidine type or other) groups.

Within the meaning of the invention, HALS groups can be defined as a cyclic hydrocarbon chain (HALS) of formula:

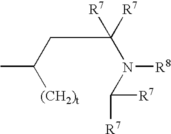

in which
the R⁷ radicals, which are identical to or different from one another, are chosen from linear or branched alkyl radicals having from 1 to 3 carbon atoms, the phenyl radical and the benzyl radical;
R⁸ is chosen from a hydrogen atom, linear or branched alkyl radicals having from 1 to 12 carbon atoms, alkylcarbonyl radicals, where the alkyl residue is a linear or branched residue having from 1 to 18 carbon atoms, the phenyl radical, the benzyl radical and an 0 radical;
t is a number chosen from 0 and 1;
preferably, the R⁷ radicals are methyls, the R⁸ radical is a hydrogen number or a methyl radical, and t is advantageously a number equal to 1.

The aminosalifiable or salified units are advantageously chosen so that they are capable of bonding to the textile support on which the emulsion is applied, so as to provide adhesion, this being the case without harming the water solubility desirable for the promoter (C).

For further details with regard to these promoters (C) of aminosalifiable or salified and hydroxylated water-soluble silicone resin type and with regard to their preparation, reference may be made to patent FR-B-2 753 708 or to European patent application EP-A-0 675 128, the contents of which are incorporated by reference in the present account.

Mention may in particular be made, as specific examples of aminosalifiable units, of:
aminopropyl: (H₂N)(CH₂)₃—
N-methyl-3-aminopropyl: (H₃CNH)(CH₂)₃—
N-aminoethyl-3-aminopropyl: (H₂N(CH₂)₂NH(CH₂)₃—
C₆H₅CH₂NH(CH₂)₂(NH)(CH₂)₃—
3-ureidopropyl: (H₂NCONH)(CH₂)₃—
3-(4,5-dihydroimidazol-1-yl)propyl:

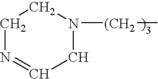

optionally, the promoter comprising aminosalifiable units can also carry nonaminated functional groups, such as follows:
3-methacryloyloxypropyl: (H₂C═C)(CH₃)(COO)(CH₂)₃—
3-glycidyloxypropyl: 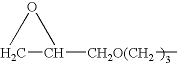
3-mercaptopropyl: (HS)(CH₂)₃—
3-chloropropyl: (Cl)(CH₂)₃—
vinyl: CH₂═CH—

it being possible for these units to be incorporated by techniques known to a person skilled in the art, in particular by cohydrolysis/cocondensation of an aminated alkoxysilane with a nonaminated alkoxysilane carrying the units described above.

It is also possible to add alkoxysilanes carrying these nonaminated units to the emulsion comprising the salified aminated silane.

One of the essential characteristics of the promoter (C) selected in accordance with the invention is that of being salified through aminated units which are as described above and which comprise at least one ≡N⁺ X⁻, with X representing a counteranion chosen from carboxylates or halides, preferably a lactate, an acetate or a chloride.

In order for the promoter (C) to be salified, it is advisable to see to it that the continuous aqueous phase of the dispersion has a pH such that this promoter (C) (preferably a hydroxylated POS resin) is maintained in the ionized form. The pH is chosen, in a way known per se, according to the pKa of the acid which corresponds to the counteranion employed.

The preferred promoter (C) in the hydroxylated resin form is included in the continued aqueous phase of the dispersion. It is dissolved or finely dispersed therein.

According to one alternative form, it is possible to envisage only a portion of the promoter (C) being in the salified form, the remainder being nonsalified.

The mixtures of promoters (C) of different natures are also covered by the invention.

The silicone phase of the emulsion employed in the process according to the invention comprises POSs intended to generate elastomer by crosslinking/curing at room temperature (23° C.) according to a polyaddition mechanism. It is possible to accelerate the crosslinking by thermal activation at a temperature greater than room temperature. Polyaddition room temperature vulcanizable elastomers and polyaddition hot vulcanizable elastomers come within the scope of the invention.

These polyorganosiloxanes, the main constituents of the compositions according to the invention, can be linear, branched or crosslinked and comprise hydrocarbon radicals and/or reactive groups, such as, for example, hydroxyl groups, hydrolyzable groups, alkenyl groups, hydrogen atoms, and the like. It should be noted that organopolysiloxane compositions are fully described in the literature and in particular in the work by Walter Noll “Chemistry and Technology of Silicones”, Academic Press, 1968, 2nd edition, pages 386 to 409.

More specifically, the POSs, which are the main constituents of the compositions according to the invention, are composed of siloxyl units of general formula:
R⁹ₙSiO_{4-n/2} (II)

and/or of siloxyl units of formula:
ZₙR⁹_{y}SiO_{4-x-y/2} (II)

In these formulae, the various symbols have the following meanings:
the R⁹ symbols, which are identical or different, each represent a group of nonhydrolyzable hydro-carbon nature, it being possible for this radical to be:
   an alkyl or haloalkyl radical having from 1 to 5 carbon atoms and comprising from 1 to 6 chlorine and/or fluorine atoms,
   cycloalkyl and halocycloalkyl radicals having from 3 to 8 carbon atoms and comprising from 1 to 4 chlorine and/or fluorine atoms,
   aryl, alkylaryl and haloaryl radicals having 6 to 8 carbon atoms and comprising from 1 to 4 chlorine and/or fluorine atoms,
   cyanoalkyl radicals having from 3 to 4 carbon atoms;
the Z symbols, which are identical or different, each represent a hydrogen atom or an alkenyl group;
   n=an integer equal to 0, 1, 2 or 3;
   x=an integer equal to 0, 1, 2 or 3;
   y=an integer equal to 0, 1 or 2;
the sum x+y is between 1 and 3.

Mention may be made, by way of illustration, of the R⁹ organic radicals, directly bonded to the silicon atoms: methyl, ethyl, propyl, isopropyl, butyl, isobutyl, n-pentyl, t-butyl, chloromethyl, dichloromethyl, α-chloroethyl, α,β-dichloroethyl, fluoromethyl, difluoromethyl, α, β-difluoroethyl, 3,3,3-trifluoropropyl, trifluorocyclopropyl, 4,4,4-trifluorobutyl, 3,3,4,4,5,5-hexafluoropentyl, β-cyanoethyl, β-cyanopropyl, phenyl, p-chlorophenyl, m-chlorophenyl, 3, 5-dichlorophenyl, trichlorophenyl, tetrachlorophenyl, o-, p- or m-tolyl, α,α,α-trifluorotolyl, xylyl, such as 2,3-phenyl radicals or 3,4-phenyl radicals.

Preferably, the R⁹ organic radicals bonded to the silicon atoms are methyl or phenyl radicals, it being possible for these radicals to be optionally halogenated, or alternatively cyanoalkyl radicals.

The Z symbols can be hydrogen atoms or vinyl groups.

It is possible to use a great variety of two-component or single-component organopolysiloxane compositions which crosslink at room temperature or under heat by polyaddition reactions, essentially by reaction of hydrosilyl groups with alkenylsilyl groups, generally in the presence of a metal catalyst, preferably a platinum catalyst, are disclosed, for example, in patents U.S. Pat. Nos. 3,220,972, 3,284,406, 3,436,366, 3,697,473 and 4,340,709. The organopolysiloxanes participating in these compositions are generally composed of pairs based, on the one hand, on at least one linear, branched or crosslinked polysiloxane composed of units (III) in which the Z residue represents an alkenyl group and where x is at least equal to 1, optionally in combination with units (II), and, on the other hand, on at least one linear, branched or crosslinked hydropolysiloxane composed of units (III) in which the Z residue then represents a hydrogen atom and where x is at least equal to 1, optionally in combination with units (II). As regards the unsaturated polysiloxane constituent comprising units (III), it can be an oil with a dynamic viscosity at 25° C. of between 200 and 500,000 mPa·s. Use may be made, if necessary, as this constituent, of a mixture based on the abovementioned oil with an unsaturated gum with a viscosity of greater than 500,000 mPa·s which can range up to 10⁶ mPa·s.

Preferably, the emulsions used in the context of the invention additionally comprise, when polyaddition compositions are concerned, at least one non-hydroxylated silicone resin (F). These silicone resins are well-known and commercially available branched POS polymers. They exhibit, per molecule, at least two different units chosen from those of formulae R¹⁰₃SiO_{1/2} (unit M), R¹⁰₂SiO_{2/2} (unit D), R¹⁰SiO_{3/2} (unit T) and SiO_{4/2} (unit Q).

The R radicals are identical or different and are chosen from linear or branched alkyl, vinyl, phenyl or 3,3,3-trifluoropropyl radicals. Preferably, the alkyl radicals exhibit from 1 to 6 carbon atoms inclusive. More particularly, mention may be made, as alkyl radicals R, of the methyl, ethyl, isopropyl, tert-butyl and n-hexyl radicals.

Advantageously, in polyaddition-type emulsions, at least a portion of the R¹⁰ radicals are vinyl residues (content by weight of Vi in particular between 0.1 and 2%). These vinyl functional groups are carried by the M, D or T units. Mention may be made, as examples, of vinylated MDQ resins, such as MD^{Vi}Q, or alternatively MM^{Vi}Q resins.

As regards the surfactants (E) other than the protective hydrocolloid (PVA), they can be anionic (except in the case where the emulsion comprises a salified amine as promoter (C)), cationic or nonionic; in particular, they can be one or more polyethoxylated fatty alcohols. Preferably, the surfactants (E) are nonionic. The role of a surfactant will be in particular to reduce the particle size of the emulsion and optionally to improve stability.

This emulsion can also comprise other formulation additives (I), such as: a condensation catalyst which makes it possible to promote the condensation of the silanols of the aminated salified silane or POS but which does not inhibit platinum catalysis (for example, titanium or zirconium salts or optionally certain tin salts), a bactericide, one or more inorganic or organic pigments, one or more organic thickeners (poly(ethylene oxide), xanthan gum, hydroxyethylcellulose, acrylic or cationic polymers, and the like) or one or more inorganic thickeners (laponite).

Advantageously, the emulsion according to the invention comprises a system for maintaining the pH at alkaline values, for example of between 7 and 8. This system for maintaining the pH can, e.g., be sodium bicarbonate.

The agent for regulating and maintaining the pH is preferably a buffer system comprising HCO₃⁻/CO₃²⁻ and/or H₂PO₄⁻/HPO₄²⁻. Thus, in order to obtain the desired buffering effect, it will be advisable to introduce, in accordance with the invention, an HCO₃^{- and/or H}₂PO₄⁻ salt, such as, for example, NaHCO₃ and/or Na₂CO₃ and/or NaH₂PO₄ and/or Na₂HPO₄. It is obvious that any other salt with a different counteranion (e.g. K) might be suitable. In a particularly preferred way, use is made in practice of a buffer system composed of NaHCO₃, which is incorporated in the emulsion.

This makes it possible to stabilize the emulsion or the coating or padding bath produced by mixtures of the emulsions. This arrangement is disclosed in more detail in patent application FR-A-2 773 166, the content of which is incorporated by reference in the present account.

Optionally, the emulsion can comprise inorganic reinforcing or bulking fillers which are preferably chosen from fumed silicas and precipitated silicas. They have a specific surface, measured according to the BET methods, of at least 50 m²/g, in particular of between 50 and 400 m²/g, preferably of greater than 70 m²/g, a mean size of the primary particles of less than 0.1 micrometer (μm) and a bulk density of less than 200 g/liter.

These hydrophilic silicas are preferably incorporated as such in the (continuous) aqueous phase of the emulsion. According to one alternative form, these silicas can optionally be treated with one or more of the organosilicon compounds commonly used for this use. According to another alternative form, the silicas can be predispersed in the silicone oil. These compounds include methylpolysiloxanes, such as hexamethyldisiloxane or octamethylcyclotetrasiloxane, methylpolysilazanes, such as hexamethyldisilazane or hexamethylcyclotrisilazane, chorosilanes, such as dimethyldichlorosilane, trimethylchlorosilane, methyvinyldichlorosilane or dimethylvinylchlorosilane, or alkoxysilanes, such as dimethyldimethoxysilane, dimethylvinylethoxysilane or trimethylmethoxysilane. During this treatment, the silicas can increase their starting weight up to a degree of 20%.

It is also possible to use other inorganic fillers in addition to or in place of the siliceous fillers, such as calcium carbonate, ground quartz, calcined clays and diatomaceous earths, optionally in the form of an aqueous dispersion (slurry).

As regards nonsiliceous inorganic materials, they may be involved as semireinforcing inorganic filler, bulking inorganic filler or inorganic filler with specific properties. Examples of these non-siliceous fillers, which can be used alone or as a mixture, are carbon black, titanium dioxide, aluminum oxide, hydrated alumina, expanded vermiculite, unexpanded vermiculite, calcium carbonate, zinc oxide, mica, talc, iron oxide, barium sulfate and slaked lime. These fillers have a particle size generally of between 0.001 and 300 Mm and a BET surface of less than 100 m²/g.

Use may generally be made of 0.5 to 60% by weight, preferably of 10 to 25% by weight, of filler, with respect to the weight of the silicone phase of the formulation.

The composition of the emulsion employed in the context of the invention is, for example, as follows:
100 parts by weight of an α,ω-divinylated POS oil (A), the content of vinyl groups of which is between 2 and 100 meq/100 g;
0 to 150 parts by weight of a dispersion of reinforcing, semireinforcing and/or bulking filler (J) in water or in an α,ω-divinylated POS oil (in a proportion of 10 to 60% of filler in the dispersion);
1 to 7 parts by weight of at least one POS oil (B1) comprising SiH, such that the number of Si—H groups/number of Si-alkenyl groups ratio ranges from 0.4 to 10, preferably from 0.6 to 5;
0.2 to 5 parts by weight of adhesion promoter (C), taken in the dry state;
a polyaddition catalyst (D) which is composed of at least one metal belonging to the platinum group, in a proportion of 2 to 150 ppm of platinum;
0.5 to 10 parts by weight of surfactant (E);
0 to 100 parts by weight of a POS resin (F);
0 to 1 part by weight of a crosslinking inhibitor (G);
0 to n parts by weight of a pH regulating agent (H), n being such that the pH is maintained between 7 and 8;
0 to m parts by weight of a formulation additive (I);
0 to 150 parts by weight of a dispersion of reinforcing, semireinforcing and/or bulking filler (J) in an α,ω-divinylated POS oil, in a proportion of 10 to 80% of filler in the dispersion;
40 to 2000 parts by weight of water (K), so that the final emulsion or the bath (produced by mixing several emulsions and water) used to treat the woven fabric has a solids content of between 5 and 65%.

According to another of its aspects, the present invention also relates to a process for the preparation of an aqueous POS emulsion as defined above, characterized in that emulsification is carried out by introducing the constituents (A) to (K) into the same reactor.

However, preferably, the emulsion is produced by mixing preemulsions which are each incapable of crosslinking separately owing to the fact that they do not exhibit all the reactive entities and the catalyst necessary (POS ≡SiVi+POS ≡SiH+platinum) for the polyaddition. For example, it is possible to prepare an emulsion comprising the ≡SiVi entities and the ≡SiH entities and inhibitor (part A) and a catalyzing emulsion based on platinum and on ≡SiVi oil (part B), which will be combined during the preparation of the coating bath.

This greatly facilitates the production of a stable emulsion which can be easily prepared under industrial conditions. It is possible to envisage employing ingredients (A) and/or (B) and/or (C) which are provided in the form of preemulsions comprising or not comprising the other ingredients (D) to (J).

Thus, according to one alternative form:
the following preemulsions are prepared:
   (i) a preemulsion as base of the POS (A),
   (ii) a preemulsion as base of the POS (B) (crosslinking emulsion),
   (iii) a preemulsion as base of the catalyst (D) (catalyzing emulsion) composed, for example, of an aqueous emulsion of a platinum catalyst diluted in a vinylated silicone oil;
these preemulsions are mixed, it being possible for one or other of the pre-emulsions (i) to (iii) to additionally include the surfactant (E), optionally the POS resin (F), optionally the crosslinking inhibitor (G) and/or optionally the pH regulating agent (H) and/or optionally the formulation additive (I).

Preferably, the catalyzing emulsion is added to the other silicone emulsions (in particular that based on SiH) during the formulation of the bath, before application to the architectural textile.

According to advantageous forms of the invention:
when the surfactant (E) is used as sole emulsifier, emulsification is carried out by the direct route or by phase inversion;
when a PVA (C) is used (in all or part) as sole emulsifier, the emulsification is carried out solely by the direct route;
   the direct route consisting in running the silicone phase into the aqueous solution comprising the surfactant.

Another advantageous form of the invention can consist in introducing the adhesion promoter (C), in particular the aminated salified silane or POS, solely during the preparation of the coating bath.

Another possibility might be to prepare emulsion parts A and B or preemulsions (i), (ii) and (iii) not comprising adhesion promoter and to provide for the separate incorporation of the latter during the mixing of A and B or of (i), (ii) and (iii).

Another subject matter of the present invention is the aqueous POS emulsion as defined above.

The present invention is also targeted at any architectural silicone membrane capable of being obtained in accordance with the process according to the invention from an architectural textile:
by deposition on the latter of at least one layer of an aqueous polyorganosiloxane (POS) emulsion which can be crosslinked to give an elastomer by polyaddition reactions and which is suitable for the impregnation of architectural textiles and which comprises:
   (A) at least one POS exhibiting, per molecule, at least two unsaturated functional groups of C₂-C₆ alkenyl type bonded to silicon,
   (B) at least one POS exhibiting, per molecule, at least three hydrogen atoms bonded to silicon,
   (C) at least one special adhesion promoter chosen from the group of compounds consisting of protective hydrocolloids, hydroxylated silanes and/or POSs carrying, per molecule, at least one hydroxyl group and at least one aminated and salified functional group, and their mixtures,
with the condition according to which the percentage by weight of the adhesion promoter (C) with respect to the silicone phase is strictly within the range from 0.005 to 10%, preferably from 0.03 to 5% and more preferably still from 0.05 to 4%,
   (D) at least one catalyst,
   (E) at least one surfactant,
   (F) optionally at least one POS resin comprising at least two alkenyl groups,
   G) optionally at least one crosslinking inhibitor,
   (H) optionally at least one pH regulating agent,
   (I) optionally at least one formulation additive,
   (J) optionally a filler,
   (K) and water,
and then by crosslinking the POSs present in the emulsion deposited on the architectural textile.

According to an advantageous arrangement of the invention, the architectural textile is a woven fabric chosen from the group of materials consisting of fibers and/or yarns chosen from the group of materials consisting of: glass, silica, metals, ceramic, silicon carbide, carbon, boron, natural fibers, such as cotton, wool, hemp or flax, artificial fibers, such as viscose, or cellulose fibers, synthetic fibers, such as polyesters, polyamides, polyacrylics, chlorofibers, polyolefins, synthetic rubbers, poly(vinyl alcohol), aramids, fluorofibers and phenolics.

Its Gross Calorific Value (GCV) is, notably, less than or equal to 4200 kJ/kg and preferably less than or equal to 2500 kJ/kg.

Advantageously, the architectural silicone membrane corresponding to a coated architectural textile as defined above or obtained by the process described above constitutes a membrane for interior and exterior architecture or solar protection.

Such a membrane preferably has a weight of less than 1200 g/m² and preferably of between 100 and 500 g/m².

In addition to these membranes made of flexible materials intended to be used in interior or exterior textile architecture (tarpaulins, tents, stands, marquees, and the like) or solar protection.

Woven glass fabrics coated with a thin layer which results from the coating with and the crosslinking of the emulsion according to the invention are particularly advantageous, in particular because of their good resistance to tearing and to fraying. Furthermore, they are flexible and are not subject to marking upon folding. Moreover, their Gross Calorific Value is low: GCV≦4200 kJ/kg and preferably ≦2500 kJ/kg.

The invention will now be described in more detail using nonlimiting implementational examples.

### EXAMPLES

### Example 1

### Preparation of the Emulsions Employed in the Process According to the Invention

1.1—Compounds Employed:

POS A-1: α,ω-dimethylvinylsiloxy PDMS oil, with a dynamic viscosity (tdη)=60 000 mPa·s at 23° C. and comprising 0.073% of Vi by weight)

POS A-2: hydrogenated POS oil comprising Me₂SiO and MeHSiO units with a viscosity of 25 mPa·s and comprising 0.7% of H by weight)

Surfactant (D)=either Rhodiasurf ROX, an 85% aqueous solution of an ethoxylated fatty alcohol sold by Rhodia, or PVA=10% aqueous solution of 25/140 poly(vinyl alcohol)(viscosity as a 4% solution: 23/ester value: 140) with the Rhodoviol® trademark

Adhesion promoter (B) and surfactant (D)=PVA

Catalyst (C)=Karstedt platinum diluted in a vinylated POS oil and assaying 10% of Pt

Resin (E.1)=40% solution of MDViQ resin in an α,ω-dimethylvinylsiloxy PDMS oil with a dynamic viscosity (tdη)=60 000 mPa·s at 23° C., the resin solution comprising 0.7% of Vi by weight)

(F)=ECH: ethynylcyclohexanol.

Compositions by Weight (in g):

| | | |
|---|---|---|
| | | PART |
| | | (B) |
| PART | PART | (catalyzing |
| (A1) | (A2) | emulsion) |

| | | | |
|---|---|---|---|
| POS (A-1) - vinylated oil | 280 | 280 | 106 |
| (F) = ECH | 0.7 | 0.7 | 0 |
| Resin (E.1) | 280 | 280 | 0 |
| Surfactant (D) = Rhodasurf | 35 | — | — |
| ROX | | | |
| (B) + (D) = PVA | — | 162 | 56 |
| POS (A-2) - hydrogenated oil | 25 | 25 | 0 |
| Catalyst (C) comprising 10% | — | — | 0.9 |
| of Pt | | | |
| Sorbic acid | 0.225 | 0.225 | 0 |
| 100% sodium bicarbonate | — | — | 1.9 |
| Demineralized water | 409 | 270 | 35 |
| Total | 1030 | 1018 | 200 |

Properties of the final emulsions

| | | | |
|---|---|---|---|
| Mean particle size (μm), | 0.3 | 2.9 | 2.4 |
| measured with a Coulter LS130 | | | |
| Solids content (%) | 59.6 | 59.6 | 60.9 |
| (2 g 1 h at 120° C.) | | | |

| | |
|---|---|
| SiH/SiVi (molar ratio) of the | 2.07 |
| bath obtained by mixing 100 | |
| parts by weight of emulsion A + | |
| 10 parts by weight of | |
| catalyzing emulsion B | |
| pH of the bath prepared by | between 7 and 8 |
| mixing 100 parts by weight of | |
| emulsion A + 10 parts by weight | |
| of catalyzing emulsion B | |

1.2—Procedure for the Preparation of the Emulsions:

Part (A1):

Rhodasurf ROX, 35 g of water and POS oil (A-1) in which the ECH inhibitor has been dispersed beforehand are introduced into an IKA laboratory reactor equipped with a scraping anchor stirrer and with a base (cooled by circulation of cold water). After stirring at 80 revolutions/min for 15 min, a concentrated oil/water emulsion is obtained which has the appearance of a viscous gel.

The resin (E.1) is then run in over 85 min with stirring (80 revolutions/min), the final temperature being in the region of 30° C. The mean particle size of the emulsion is then 0.28 μm.

The emulsion is stirred for a further 30 min and then the POS oil (A-2) (hydrogenated polydimethylsiloxane oil) is run in over 15 min, followed by 80 g of water.

At this stage, the mean particle size of the emulsion, characterized using a Coulter LS130, is 0.29 μm.

The emulsion is diluted by gradual addition of the balance of the demineralized water (i.e. 310 g) and then of the sorbic acid, and the final emulsion is packaged in a polyethylene bottle.

Part (A2):

The 10% aqueous solution of poly(vinyl alcohol) (Rhodoviol 25/140) and the sorbic acid are introduced into an IKA laboratory reactor equipped with a scraping anchor stirrer and with a base (cooled by circulation of cold water).

The resin (E.1) is run in over 170 min with stirring, the final temperature being in the region of 22° C.

The POS oil (A-1) (ViMe₂SiO-blocked polydimethylsiloxane oil, with a viscosity equal to 60 000 mPa·s and comprising 0.07% of Vi), in which the ethynylcyclohexanol (ECH) has been predispersed, is subsequently run in over 150 min, the final temperature reaching 17° C.

At this stage, the mean particle size of the emulsion, characterized with a Coulter LS130, is 5.9 μm.

An Ultra-Turrax rotor-stator (IKA) is then added and the emulsion is sheared for 1 h 30, 20 min at 16 000 revolutions/min and then 1 h 10 at 13 000 revolutions/min,

Initial temperature=22.9° C., final temperature=28.6° C.

The mean particle size falls to 3 μm.

The POS oil (A-2) (silicone oil comprising Me₂SiO_{2/2} and MeHSiO_{2/2} units with a viscosity of 25 mPa·s and comprising 0.7% of H by weight) is then run in over 20 min, T=24.5° C.

The emulsion is diluted by gradual addition of demineralized water over 60 min, T=27.3° C.

Part B:

The emulsion B is prepared according to the same protocol as the emulsion A2 by running the POS-1621V60000 oil (in which the catalyst (C) has been predispersed) into the 10% aqueous solution of poly(vinyl alcohol). The bicarbonate is added at the end to the diluted emulsion.

Parts A+B:

The mixing of 100 parts of A1 or A2 with 10 parts of B, plus optionally water of dilution in order to adjust the viscosity and the concentration of the bath (for the purpose of regulating the amount of silicone deposited on the woven fabric), is carried out during the formation of the coating bath, before application to the woven fabric. The pH of the bath is between 7 and 8.

### Example 2

### Process for the Application of the Emulsions of Example 1

By padding (squeezing between two rolls).

The woven fabric arrives vertically between the rolls, where emulsion is continuously deposited, the woven fabric being impregnated on both its faces on exiting from the rolls. Subsequently, the woven fabric passes into an oven for one minute.

The plant operates at 10 m/min. The temperatures of the ovens are regulated at 120° C. at the inlet and then at 160° C. at the outlet. The pressure on the squeezing rolls is of the order of 1.5 bar.

The woven fabrics are weighed before and after coating in order to measure the weight deposited.

### Example 3

### Process for the Application of the Emulsions of Example 1

This example is identical to example 2, except that the pressure on the squeezing rolls is of the order of 1 bar.

The woven fabrics are weighed before and after coating in order to measure the weight deposited.

### Example 4

### Process for the Application of the Emulsions of Example 1

By padding (squeezing between two rolls).

The woven fabric is immersed in a tank placed upstream of the squeezing rolls and arrives at an angle of 200 between the rolls, the squeezing pressure of which is 1.5 bar. Subsequently, the woven fabric passes into an oven for one minute.

The plant operates at 10 m/min. The temperatures of the ovens are regulated at 120° C. at the inlet and then at 160° C. at the outlet. The woven fabrics are weighed before and after coating in order to measure the weight deposited.

### Example 5

### Validation in Application—Properties Obtained with a Mixture of Emulsions A2+B (without Additive)

5.1 Woven Glass Fabric, Weight 350 g/m²

This woven fabric is coated according to the process of example 4 with an emulsion according to example 1 (mixture of emulsions A2+B (without additive)). The solids content of this bath was adjusted to 55.7% and then to 48%.

Under these conditions, 22 g/m², expressed on a dry basis, were deposited.

The coated woven fabric has a beautiful appearance.

The gross calorific value, measured according to NFP92-510, is 1900 kJ/kg.

The resistance to fraying is good; it is given material form by a resistance to combing, measured according to DIN54301, of greater than 35 N.

5.2 Woven Glass Fabric, Weight 200 g/m²

This woven fabric is coated according to the process of example 2 with an emulsion according to example 1 (mixture of emulsions A2+B (without additive)). The solids content of this bath was adjusted to 55.7% and then to 42%. Under these conditions, 15 g/m², expressed on a dry basis, were deposited.

The coated woven fabric has a beautiful appearance.

The gross calorific value, measured according to NFP92-510, is 2150 kJ/kg.

The resistance to fraying is good; it is given material form by a resistance to combing, measured according to DIN54301, of greater than 35 N.

5.3 Woven Glass Fabric, Weight 200 g/m²

This woven fabric is coated according to the process of example 3 with an emulsion according to example 1 (mixture of emulsions A2+B (without additive)). The solids content of this bath was adjusted to 55.7% and then to 42%. Under these conditions, 12 g/m², expressed on a dry basis, were deposited.

The coated woven fabric has a beautiful appearance, in particular on the upper face which has received the emulsion.

The gross calorific value, measured according to NFP92-510, is 1800 kJ/kg.

The resistance to fraying is good; it is given material form by a resistance to combing, measured according to DIN54301, of greater than 35 N.

### Example 6

### Incorporation in the Emulsion A of the Aminated Salified Silane or of PVA during the Preparation of the Coating Bath

Tests on addition of adhesion promoters were carried out in order to render the emulsions more adherent to the glass fiber or synthetic fibers. The water-soluble silanes tested are:

6.1 Comparative Test:

The promoter is Dynasylan® HS 2926, sold by Degussa-Sivento, epoxy silane, pH=3, at 60% in water

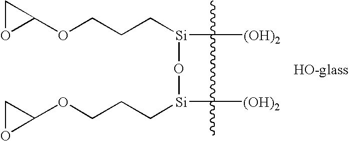

6.2 Test 6.2

Dynasylan® HS 2929 sold by Degussa-Sivento, salified and condensed acrylic aminated silane, pH=4, at 60% in water.

6.3 Test 6.3

The promoter is Silquest® VS142, sold by Witco-OSI, aminated silane, pH=12, at approximately 25% in water, which is composed of an oligomer of the silane described below, partially condensed via its SiOH groups.

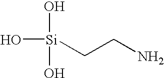

This silane was used after prior salification obtained by neutralization of the aqueous solution by addition of a sufficient amount of acetic acid to bring its pH to between 6 and 7.

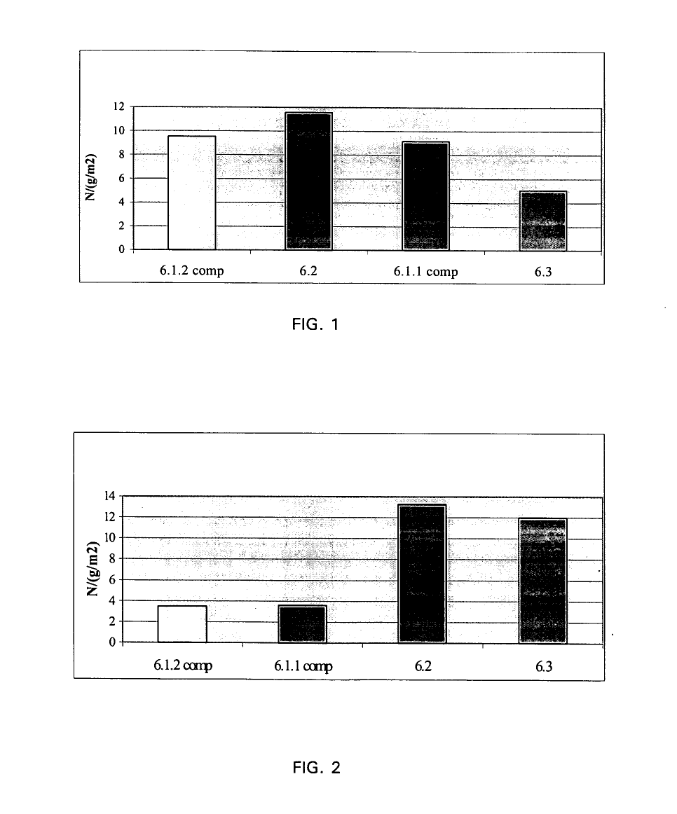

These promoters of tests 6.1, 6.2 and 6.3 are added directly to part A2 of the emulsion of example 1, 24 h before preparing the bath (mixture A2+B), at a level of 2% (by dry weight of silane with respect to the oil). When the bath is prepared, tests on coating woven fabric by screen printing and peel tests are carried out with the protocol described below. The results of adhesion to polyester and to woven glass fiber of cloth type, expressed by the peel strength (measured in N/(g/m²), according to a 180° peel test described below), are represented in the appended FIGS. 1 and 2.

FIG. 1 corresponds to a textile made of woven polyester fabric.

FIG. 2 corresponds to a textile made of woven glass fabric.

N.B.: in the two figures, the control corresponds to the adhesion results obtained when the woven fabric is treated with the emulsion prepared as described in §1.2 of example 1, without addition of an additional adhesion promoter.

It is observed that the aminated and salified silanes markedly improve the adhesion to woven glass fabric. The aminated and salified silane 6.2 also improves the adhesion to woven polyester fabric.

The 180° peel test on a fibrous support is a measure of the adhesion of PA emulsions. The procedure of this test is as follows:

1. Principle

Measurement of the force necessary to detach 2 bands of supports coated with the test mixture and crosslinked on architectural textiles.

2. Reactants

Use of methylene blue for facilitating the locating of the superimposition of the 2 coated strips of woven fabric (not essential to the measurement).

3. Equipment
1 heating press: the temperature of the plates is set at 120° C.
2 ovens: one at 80° C. and one at 160° C.
Installation for application by screen printing mode (use of a cloth with a mesh diameter˜200 μm).
1 balance.
1 Lhomargy® DY 30 dynamometer
4. Procedure

a—Preparation of the Test Specimens

Support Woven Fabric Used:

Bands of ˜12 by 17 cm are cut out from the architectural textile. To facilitate this operation and to prevent fraying, the outlines marked out on the woven fabric are coated with a silicone elastomer which crosslinks rapidly under cold conditions (RTC). Thus, small amounts of RTC are deposited using a gun and are spread along the outlines using a spatula. Once the RTC has dried, it will be easier to cut out the bands.

Preparation of the Mixture:

10 g of part B per 100 g of part A. ˜20 g of mixture are needed to prepare 3 tests. One drop of methylene blue is added to facilitate the super-imposition of the 2 coated faces.

b—Application

Two bands of the mixture of 10 cm by 5 are deposited, in parallel and at a distance of ˜2 cm, by the screen printing method. The piece of textile is weighed before and after coating in order to know the amount deposited.

Drying and Crosslinking Under the Press:
5 min at 80° C.
Superimposition of the 2 coated faces over one another
5 min under the press at 120° C. (deposited between 2 sheets of paper), at˜2 tonnes
5 min at 160° C.
left standing at ambient temperature for ˜½ day.

6.4 Application Tests with the Following Mixtures: Part A1+B, A1+B+salified VS142 and A1+B+PVA:

These impregnations are carried out on a woven glass fabric support (200 g/m²) by padding according to example 3. The samples are passed into an oven at 150° C. for 2 min. The weights deposited are comparable and representative.

The tests of resistance to combing are carried out in order to determine the ability of the samples to withstand fraying.

| | | Resistance to |
|---|---|---|
| | Weight | combing |
| Part | deposited | (DIN 54301) |
| A1 + B | 18-20 | 11 |
| A1 + B + salified VS 142 | 18 | 44 |
| A1 + B + 1.8% PVA | 19-20 | 24 |
| A1 + B + 3.6% PVA | 17 | 14 |
| A1 + B + 5.4% PVA | 16-19 | 16 |

It could be observed that the best resistance to fraying given material form by the combing test is obtained by virtue of the composition A1+B+VS142 (presence of the salified aminated silane).

1. A process for preparing architectural silicone membranes by coating an architectural textile with at least one silicone elastomer layer, comprising the following stages:
a stage of deposition, on said architectural textile, of at least one layer of an aqueous polyorganosiloxane (POS) emulsion which can be crosslinked to give an elastomer by polyaddition reactions, which emulsion comprises:
(A) at least one POS exhibiting, per molecule, at least two unsaturated functional groups of C₂-C₆ alkenyl type bonded to silicon,
(B) at least one POS exhibiting, per molecule, at least three hydrogen atoms bonded to silicon,
(C) at least one special adhesion promoter chosen from the group of compounds consisting of protective hydrocolloids, hydroxylated silanes and/or POSs carrying, per molecule, at least one hydroxyl group and at least one aminated and salified functional group, and their mixtures,
with the condition according to which the percentage by weight of the adhesion promoter (C) with respect to the silicone phase is strictly within the range from 0.005 to 10%, preferably from 0.03 to 5% and more preferably still from 0.05 to 4%,
(D) at least one catalyst,
(E) at least one surfactant,
(F) optionally at least one POS resin comprising at least two alkenyl groups,
(G) at least one crosslinking inhibitor,
(H) optionally at least one pH regulating agent,
(I) optionally at least one formulation additive,
(J) optionally a filler,
(K) and water,
and then a crosslinking stage, so as to obtain an architectural textile coated with an elastomer layer, so that the ratio of the weight of the coating, expressed on a dry basis, to the weight of the architectural textile is less than 0.2 and preferably between 0.05 and 0.11.

2. The process as claimed in claim 1, wherein the deposition stage is a coating stage.

3. The process as claimed in claim 2, wherein the coating is carried out by knife, in particular by knife over roll, floating knife and knife over carpet, by padding, in particular by squeezing between two rolls, or also by licking roll, rotary machine, reverse roll, by transfer, by screen printing, by heliography or by spraying.

4. The process as claimed in claim 1, wherein the architectural textile comprises fibers and/or yarns chosen from the group of materials consisting of: glass, silica, metals, ceramic, silicon carbide, carbon, boron, natural fibers, such as cotton, wool, hemp or flax, artificial fibers, such as viscose, or cellulose fibers, synthetic fibers, such as polyesters, polyamides, polyacrylics, chlorofibers, polyolefins, synthetic rubbers, poly(vinyl alcohol), aramids, fluorofibers and phenolics.

5. The process as claimed in claim 1, wherein the architectural textile, when it is chosen from inorganic materials, has, once coated, a Gross Calorific Value (GCV) of less than or equal to 4200 kJ/kg.

6. An architectural textile or architectural silicone membrane obtained from an architectural textile:
by deposition on the latter of at least one layer of an aqueous polyorganosiloxane (POS) emulsion which can be crosslinked to give an elastomer by polyaddition reactions and which is suitable for the impregnation of architectural textiles and which comprises:
(A) at least one POS exhibiting, per molecule, at least two unsaturated functional groups of C₂-C₆ alkenyl type bonded to silicon,
(B) at least one POS exhibiting, per molecule, at least three hydrogen atoms bonded to silicon,
(C) at least one special adhesion promoter chosen from the group of compounds consisting of protective hydrocolloids, hydroxylated silanes and/or POSs carrying, per molecule, at least one hydroxyl group and at least one aminated and salified functional group, and their mixtures,
with the condition according to which the percentage by weight of the adhesion promoter (C) with respect to the silicone phase is strictly within the range from 0.005 to 10%, preferably from 0.03 to 5% and more preferably still from 0.05 to 4%,
(D) at least one catalyst,
(E) at least one surfactant,
(F) optionally at least one POS resin comprising at least two alkenyl groups,
(G) optionally at least one crosslinking inhibitor,
(H) optionally at least one pH regulating agent,
(I) optionally at least one formulation additive,
(J) optionally a filler,
(K) and water,
and then by crosslinking the POSs present in the emulsion deposited on the textile.

7. The membrane as claimed in claim 6, wherein it is composed of a textile comprising fibers and/or yarns chosen from the group of materials consisting of: glass, silica, metals, ceramic, silicon carbide, carbon, boron, natural fibers, such as cotton, wool, hemp or flax, artificial fibers, such as viscose, or cellulose fibers, synthetic fibers, such as polyesters, polyamides, polyacrylics, chlorofibers, polyolefins, synthetic rubbers, poly(vinyl alcohol), aramids, fluorofibers and phenolics.

8. The membrane as claimed in claim 6, wherein its Gross Calorific Value (GCV) is less than or equal to 4200 kJ/kg and preferably less than or equal to 2500 kJ/kg.

9. The membrane as claimed in claim 6, wherein it is intended for interior and exterior architecture or solar protection.

10. The membrane as claimed in claim 9, wherein it exhibits a weight of less than 1200 g/m² and preferably of between 100 and 500 g/m².
